(19) United States
(12) Patent Application Publication
(10) Pub. No.: US 2009/0245576 A1
(43) Pub. Date: Oct. 1, 2009

(54) METHOD, APPARATUS, AND PROGRAM STORAGE MEDIUM FOR DETECTING OBJECT

(75) Inventor: Yi HU, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/407,607

(22) Filed: Mar. 19, 2009

(30) Foreign Application Priority Data
Mar. 25, 2008 (JP) 2008-078641

(51) Int. Cl. G06K 9/00

(52) U.S. Cl. 382/103

(57) ABSTRACT

The invention relates to an object detecting method for detecting a specific kind of object such as a human head and a human face from an image expressed by two-dimensionally arrayed pixels, the object detecting method including an image group producing step of producing an image group including an original image of the object detecting target and at least one thinned-out image by thinning out pixels constituting the original image at a predetermined rate or by thinning out the pixels at the predetermined rate in a stepwise manner; and a stepwise detection step of detecting the specific kind of object from the original image by sequentially repeating plural extraction processes from an extraction process of applying a filter acting on a relatively small region to a relatively small image toward an extraction process of applying a filter acting on a relatively wide region to a relatively large image.

### BACKGROUND OF THE INVENTION

1. Field of the Invention

The present invention relates to an object detecting method and an object detecting apparatus for detecting a specific kind of object such as a human head and a human face from an image expressed by two-dimensionally arrayed pixels and an object detecting program storage medium for causing an operation device executing a program to work as the object detecting apparatus.

2. Description of the Related Art

For example, a human head appears on images in various sizes and various shapes. Although a person can instantaneously and easily distinguish a human head from other items when seeing the human head with eyes, it is very difficult for a device to automatically distinguish the human head from other items. On the other hand, it is considered that the detection of a human head on images is important preprocessing and a fundamental technique in person detection. Particularly, in video image monitoring, there is a growing need for putting a technique capable of accurately detecting the human head to practical use as preprocessing of automatic and accurate person detection, person tracking, and measurement of a flow of people in various environments.

Regarding methods of detecting a human head, conventionally various methods are proposed (for example, see Japanese Patent Application Publication Nos. 2004-295776, 2005-92451, 2005-25568, and 2007-164720, and also a non-patent document by Jacky S. C. Yuk, Kwan-Yee K. Wong, Ronald H. Y. Chung, F. Y. L Chin, and K. P. Chow, titled “Real-time multiple head shape detection and tracking system with decentralized trackers”, ISDA, 2006). In these proposed detection methods, a circle or an ellipse is applied to a human head by various techniques on the assumption that the human head is basically circular or elliptic.

For example, Japanese Patent Application Publication No. 2004-295776 discloses a technique in which an ellipse is extracted by performing Hough transform vote to a brightness edge hierarchy image group produced from continuous two frame images by temporal difference and spatial difference, thereby detecting a person's head.

Japanese Patent Application Publication No. 2005-92451 discloses a technique in which a spatial distance image is produced from the video images taken by at least two cameras, an object is determined by dividing a region of the produced spatial distance image using a labeling technique, and circle fitting is applied to the determined object to obtain a person's head.

Japanese Patent Application Publication No. 2005-25568 discloses a technique in which the comparison is performed with not a simple ellipse template but a pattern (a part of the ellipse) as a reference pattern when the determination of the head is made, the pattern being obtained by decreasing intensity near a contact point with a tangential line perpendicular to an edge direction of an edge image.

Japanese Patent Application Publication No. 2007-164720 discloses a technique in which a head region that is of a part of a foreground is estimated by computing a moment or a barycenter in a foreground region of a person extracted from an input image, and the ellipse applied to the person's head is determined based on a shape of the region.

In the document by Jacky S. C. Yuk, Kwan-Yee K. Wong, Ronald H. Y. Chung, F. Y. L Chin, and K. P. Chow, titled “Real-time multiple head shape detection and tracking system with decentralized trackers”, ISDA, 2006, a technique is disclosed, in which a semicircle is found to seek a head candidate using the Hough transform, a profile probability of each point on a profile line is computed from the head candidate to determine whether or not the head candidate is a head.

A human head appears in various sizes on images, and sometimes plural human heads in different sizes appear simultaneously. In the video image monitoring, it is necessary to recognize the human heads in various sizes in real time, and detecting the human heads appearing in various sizes at high speed is becoming a big issue. This issue is not limited to the detection of head, but also common to the detection of face, for example, and widely common to the detection of a specific kind of object appearing in various sizes on the image.

### SUMMARY OF THE INVENTION

The present invention has been made in view of the above circumstances and provides an object detecting method and an object detecting apparatus which can detect an object of a detecting target at high speed even if the object appears on the image in various sizes and an object detecting program storage medium which causes an operation device executing a program to work as the object detecting apparatus which detects the object at high speed.

The object detecting method of the present invention is an object detecting method which detects a specific kind of object from an image expressed by two-dimensionally arrayed pixels, including:

an image group producing step of producing an image group including an original image of an object detecting target and at least one thinned-out image by thinning out pixels constituting the original image at a predetermined rate or by thinning out the pixels at the predetermined rate in a stepwise manner; and

a stepwise detection step of detecting the specific kind of object from the original image by sequentially repeating plural extraction processes from an extraction process of applying a filter acting on a relatively narrow region to a relatively small image toward an extraction process of applying a filter acting on a relatively wide region to a relatively large image,

the plural extraction processes including:

a first extraction process of extracting a primary candidate region where an evaluated value exceeding a predetermined first threshold is obtained by applying a first filter in a filter group including plural filters to a relatively small first image in the image group produced in the image group producing step, the first filter acting on a relatively narrow region, each of the plural filters acting on a region two-dimensionally spread on the image to produce an evaluated value, the evaluated value indicating an existing probability of the specific kind of object in the region, the plural filters acting on regions having plural sizes respectively, the number of pixels corresponding to the size of the region on the image being changed at the predetermined rate or changed at the predetermined rate in the stepwise manner in the plural sizes; and

a second extraction process of extracting a secondary candidate region where an evaluated value exceeding a predetermined second threshold is obtained by applying a second filter in the filter group to a region corresponding to the primary candidate region in a second image in which the number of pixels is larger than that of the first image in the image group produced in the image group producing step, the second filter acting on a region wider than that of the first filter.

In the object detecting method in accordance with the first aspect of the invention, the process in which the plural filters are prepared in order to act on the regions having the plural sizes different from one another in the stepwise manner to detect the object, the image group including the images having the plural sizes is produced for the original image of the detecting target by performing the thin-out, and the region is extracted by applying filter to the image is sequentially performed from the process of applying the filter acting on the relatively narrow region to the relatively small image toward the process of applying the filter acting on the relatively wide region to the relatively large image. Additionally, in the latter process, the filter acts only on the region extracted in the immediately-preceding process. Therefore, high-speed processing can be realized.

Here, it is preferable that the image group producing step is a step of performing an interpolation operation to the original image to produce one interpolated image or plural interpolated images, in addition to the image group, the one interpolated image or the plural interpolated images constituting the image group, the number of pixels of the one interpolated image being in a range where the number of pixels is larger than that of the thinned-out image obtained by thinning out the original image at the predetermined rate and smaller than that of the original image, the plural interpolated images having the numbers of pixels which are different from one another within the range, and of producing a new image group by thinning out pixels constituting the interpolated image at the predetermined rate for each of the produced at least one interpolated image or by thinning out pixels at the predetermined rate in the stepwise manner, the new image group including the interpolated image and at least one thinned-out image obtained by thinning out the pixel of the interpolated image, and

the stepwise detection step is a step of detecting the specific kind of object from each of the original image and the at least one interpolated image by sequentially repeating the extraction processes to each of the plural image groups produced in the image group producing step from the extraction process of applying the filter acting on the relatively narrow region to the relatively small image toward the extraction process of applying the filter acting on a relatively wide region to the relatively large image.

Thus, the objects having various sizes can be detected when the plural image groups having the different sizes are produced and used to detect the object.

Further, it is preferable that, in the object detecting method, plural kinds of filters are prepared for each region having one size, each of the plural kinds of filters computing an outline of the specific kind of object and one of feature quantities in the specific kind of object,

a correlation between the feature quantity and a primary evaluated value is prepared, the feature quantity being computed by each filter, the primary evaluated value indicating a probability of the specific kind of object, and

the stepwise detection step is a step of computing the plural feature quantities by applying the plural kinds of filters to one region according to the size of the region, of obtaining the primary evaluated value corresponding to each feature quantity, and of determining whether or not the region is a candidate region where the specific kind of object exists by comparing a secondary evaluated value and a threshold, the secondary evaluated value being obtained by integrating the plural primary evaluated values.

Thus, the plural filters which extract the outline of the object and the feature quantities indicating the various features inside the object are combined, so that high-accuracy extraction can be performed compared with the conventional operation in which attention is focused only on the outline shape.

It is even preferable that the object detecting method further includes a region integrating step of integrating, when plural regions are detected in the stepwise detection step, the plural regions into one region according to a degree of overlap between the plural regions.

For example, in cases where the person's head is set as the detecting target, both the first region and the second region may be extracted as the region of the person's head. The first region includes the person face in the substantial center of the image. The second region includes the head including the hair of the same person in the substantial center of the same image. In the second region, compared with the first region, the head partially overlaps another item while the head is partially separated from another item. In such cases, when the object is set as the detecting target, the region integrating step is performed to integrate the plural regions into one region according to the degree of the overlap between the plural regions.

It is more preferable that the object detecting method further includes a differential image producing step of obtaining continuous images to produce a differential image between different frames, the continuous images including plural frames, the differential image being used as an image of the object detecting target.

For example, in cases where the person's head is set as the object of the detecting target, because the person moves on the video image, the differential image is produced and set as a original image of the object detecting target, which allows the head detection (object detection) in which the feature of the movement of the person is taken.

The higher-accuracy object detection can be performed by setting both the individual images of the pre-production of the differential image and the differential image at the original image of the object detecting target.

Here, the object detecting method may be one in which the filter group includes the plural filters producing the evaluated values, the evaluated value indicating an existing probability of a human head, and

a detecting target of the object detecting method is the human head appearing in the image.

The object detecting method of the invention is suitably applied when the person's head is set as the detecting target. However, the object detecting method of the invention is not only suitable to the detection of the person's head, but also the object detecting method of the invention can be applied to various fields, such as the detection of the person's face and the outdoor detection of the wild bird, in which the specific kind of object is detected.

Moreover, the object detecting apparatus of the present invention is an object detecting apparatus which detects a specific kind of object from an image expressed by two-dimensionally arrayed pixels, including:

a filter storage section in which a filter group including plural filters is stored, each of the plural filters acting on a region two-dimensionally spread on the image to produce an evaluated value, the evaluated value indicating an existing probability of the specific kind of object in the region, the plural filters acting on regions having plural sizes respectively, the number of pixels corresponding to the size of the region on the image being changed at a predetermined rate or changed at the predetermined rate in a stepwise manner in the plural sizes;

an image group producing section which produces an image group including an original image of an object detecting target and at least one thinned-out image by thinning out pixels constituting the original image at the predetermined rate or by thinning out the pixels at the predetermined rate in the stepwise manner; and

a stepwise detection section which detects the specific kind of object from the original image by sequentially repeating plural extraction processes from an extraction process of applying a filter acting on a relatively narrow region to a relatively small image toward an extraction process of applying a filter acting on a relatively wide region to a relatively large image,

the plural extraction processes including:

a first extraction process of extracting a primary candidate region where an evaluated value exceeding a predetermined first threshold is obtained by applying a first filter in the filter group stored in the filter storage section to a relatively small first image in the image group produced by the image group producing section, the first filter acting on a relatively narrow region; and

a second extraction process of extracting a secondary candidate region where an evaluated value exceeding a predetermined second threshold is obtained by applying a second filter in the filter group stored in the filter storage section to a region corresponding to the primary candidate region in a second image in which the number of pixels is larger than that of the first image in the image group produced by the image group producing section, the second filter acting on a region wider than that of the first filter.

Here, in the object detecting apparatus, it is preferable that the image group producing section performs an interpolation operation to the original image to produce one interpolated image or plural interpolated images in addition to the image groups, the one interpolated image or the plural interpolated images constituting the image group, the number of pixels of the one interpolated image being in a range where the number of pixels is larger than that of the thinned-out image obtained by thinning out the original image at the predetermined rate and smaller than that of the original image, the plural interpolated images having the numbers of pixels which are different from one another within the range, and the image group producing section produces a new image group by thinning out pixels constituting the interpolated image at the predetermined rate for each of the produced at least one interpolated image or by thinning out pixels at the predetermined rate in the stepwise manner, the new image group including the interpolated image and at least one thinned-out image obtained by thinning out the pixel of the interpolated image, and

the stepwise detection section detects the specific kind of object from each of the original image and the at least one interpolated image by sequentially repeating the extraction processes to each of the plural image groups produced by the image group producing section from the extraction process of applying the filter acting on the relatively narrow region to the relatively small image toward the extraction process of applying the filter acting on the relatively wide region to the relatively large image.

Also, in the object detecting apparatus, it is preferable that plural kinds of filters are stored in the filter storage section, the plural kinds of filters being prepared for each region having one size, each of the plural kinds of filters computing an outline of the specific kind of object and one of feature quantities in the specific kind of object,

a correlation between the feature quantity and a primary evaluated value is also stored in the filter storage section, the feature quantity being computed by each filter, the primary evaluated value indicating a probability of the specific kind of object, and

the stepwise detection section computes the plural feature quantities by applying the plural kinds of filters to one region according to the size of the region, obtains the primary evaluated value corresponding to each feature quantity, and determines whether or not the region is a candidate region where the specific kind of object exists by comparing a secondary evaluated value and a threshold, the secondary evaluated value being obtained by integrating the plural primary evaluated values.

It is preferable that the object detecting apparatus further includes a region integrating section which integrates, when plural regions are detected by the stepwise detection section, the plural regions into one region according to a degree of overlap between the plural regions.

Moreover, it is preferable that the object detecting apparatus further includes a differential image producing section which obtains continuous images to produce a differential image between different frames, the continuous images including plural frames, the differential image being used as an image of the object detecting target.

Here, it is preferable that, in the object detecting apparatus, the filter group including the plural filters producing the evaluated values is stored in the filter storage section, the evaluated value indicating an existing probability of a human head, and a detecting target of the object detecting apparatus is the human head appearing in the image.

In addition, the storage medium of the present invention is a storage medium in which an object detecting program is stored, the object detecting program being executed in an operation device, the operation device executing a program, the object detecting program causing the operation device to work as an object detecting apparatus, the object detecting apparatus detecting a specific kind of object from an image expressed by two-dimensionally arrayed pixels, the object detecting apparatus including:

a filter storage section in which a filter group including plural filters is stored, each of the plural filters acting on a region two-dimensionally spread on the image to produce an evaluated value, the evaluated value indicating an existing probability of the specific kind of object in the region, the plural filters acting on regions having plural sizes respectively, the number of pixels corresponding to the size of the region on the image being changed at a predetermined rate or changed at the predetermined rate in a stepwise manner in the plural sizes;

an image group producing section which produces an image group including an original image of an object detecting target and at least one thinned-out image by thinning out pixels constituting the original image at the predetermined rate or by thinning out the pixels at the predetermined rate in the stepwise manner; and

a stepwise detection section which detects the specific kind of object from the original image by sequentially repeating plural extraction processes from an extraction process of applying a filter acting on a relatively narrow region to a relatively small image toward an extraction process of applying a filter acting on a relatively wide region to a relatively large image,

the plural extraction processes including:

a first extraction process of extracting a primary candidate region where an evaluated value exceeding a predetermined first threshold is obtained by applying a first filter in the filter group stored in the filter storage section to a relatively small first image in the image group produced by the image group producing section, the first filter acting on a relatively narrow region; and

a second extraction process of extracting a secondary candidate region where an evaluated value exceeding a predetermined second threshold is obtained by applying a second filter in the filter group stored in the filter storage section to a region corresponding to the primary candidate region in a second image in which the number of pixels is larger than that of the first image in the image group produced by the image group producing section, the second filter acting on a region wider than that of the first filter.

Here, in the storage medium, it is preferable that the image group producing section performs an interpolation operation to the original image to produce one interpolated image or plural interpolated images in addition to the image groups, the one interpolated image or the plural interpolated images constituting the image group, the number of pixels of the one interpolated image being in a range where the number of pixels is larger than that of the thinned-out image obtained by thinning out the original image at the predetermined rate and smaller than that of the original image, the plural interpolated images having the numbers of pixels which are different from one another within the range, and the image group producing section produces a new image group by thinning out pixels constituting the interpolated image at the predetermined rate for each of the produced at least one interpolated image or by thinning out pixels at the predetermined rate in the stepwise manner, the new image group including the interpolated image and at least one thinned-out image obtained by thinning out the pixel of the interpolated image, and

the stepwise detection section detects the specific kind of object from each of the original image and the at least one interpolated image by sequentially repeating the extraction processes to each of the plural image groups produced by the image group producing section from the extraction process of applying the filter acting on the relatively narrow region to the relatively small image toward the extraction process of applying the filter acting on the relatively wide region to the relatively large image.

Additionally, in the storage medium of the present invention, it is preferable that plural kinds of filters are stored in the filter storage section, the plural kinds of filters being prepared for each region having one size, each of the plural kinds of filters computing an outline of the specific kind of object and one of feature quantities in the specific kind of object,

a correlation between the feature quantity and a primary evaluated value is also stored in the filter storage section, the feature quantity being computed by each filter, the primary evaluated value indicating a probability of the specific kind of object, and

the stepwise detection section computes the plural feature quantities by applying the plural kinds of filters to one region according to the size of the region, obtains the primary evaluated value corresponding to each feature quantity, and determines whether or not the region is a candidate region where the specific kind of object exists by comparing a secondary evaluated value and a threshold, the secondary evaluated value being obtained by integrating the plural primary evaluated values.

Still more, in the storage medium of the present invention, it is preferable that the operation device is caused to work as the object detecting apparatus, the object detecting apparatus further including a region integrating section which integrates, when plural regions are detected by the stepwise detection section, the plural regions into one region according to a degree of overlap between the plural regions.

Further, in the storage medium of the present invention, it is preferable that the operation device is caused to work as the object detecting apparatus, the object detecting apparatus further including a differential image producing section which obtains continuous images to produce a differential image between different frames, the continuous images including plural frames, the differential image being used as an image of the object detecting target.

Moreover, in the storage medium of the present invention, it is preferable that the filter group including the plural filters producing the evaluated values is stored in the filter storage section, the evaluated value indicating an existing probability of a human head, and the object program causes the operation device to work as the object detecting apparatus whose detecting target is the human head appearing in the image.

Accordingly, even if the object of the detecting target appears on the image in various sizes, the object can be detected at high speed.

### BRIEF DESCRIPTION OF THE DRAWINGS

FIG. 1 is a schematic diagram showing a monitoring camera system into which an embodiment of the invention is incorporated;

FIG. 2 is a perspective view showing an appearance of a personal computer shown by one block of FIG. 1;

FIG. 3 shows a hardware configuration of the personal computer;

FIG. 4 is a flowchart showing an example of a head detecting method performed with the personal computer of FIGS. 1 to 3;

FIG. 5 is a block diagram showing an example of a head detecting apparatus;

FIG. 6 is a detailed flowchart showing a learning step in the head detecting method of FIG. 4;

FIG. 7 is an explanatory view of multi-resolution expansion processing;

FIG. 8 is an explanatory view of moving image differential processing;

FIG. 9 is an explanatory view of a filter structure;

FIG. 10 illustrates various filters;

FIG. 11 is a conceptual view of machine learning;

FIG. 12 is a conceptual view of a teacher image;

FIG. 13 is a conceptual view showing various filters and learning results of the filters;

FIG. 14 is an explanatory view showing weighting the teacher image;

FIG. 15 is an explanatory view of a weighting method in making a transition to learning of a 16-by-16-pixel filter after an 8-by-8-pixel filter is extracted;

FIG. 16 is a schematic diagram showing processing performed by an image group producing section of FIG. 5; and

FIG. 17 is an explanatory view showing region integrating processing performed by a region integrating section.

### DETAILED DESCRIPTION OF THE INVENTION

Exemplary embodiments of the invention will be described below with reference to the drawings.

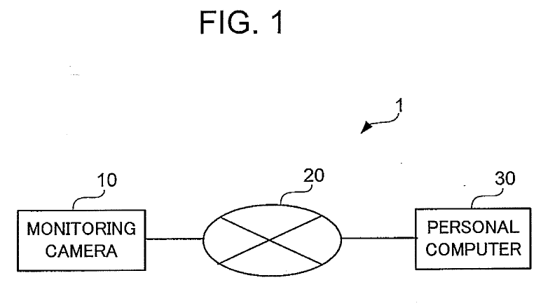

FIG. 1 is a schematic diagram showing a monitoring camera system into which an embodiment of the invention is incorporated.

Referring to FIG. 1, a monitoring camera system 1 includes a monitoring camera 10, an Internet 20, and a personal computer 30. The personal computer 30 is operated as a head detecting apparatus which is of an object detecting apparatus according to an embodiment of the invention.

For example, the monitoring camera 10 is placed in a bank to take a picture of appearances inside the bank. The monitoring camera 10 is connected to the Internet 20, and the monitoring camera 10 transmits image data expressing a moving image to the personal computer 30 through network communication. Hereinafter the image on the data is simply referred to as “image”.

The personal computer 30 is connected to the Internet 20, and the personal computer 30 receives the moving image transmitted from the monitoring camera 10 through the network communication. The personal computer 30 collectively manages the moving images taken by the monitoring camera 10.

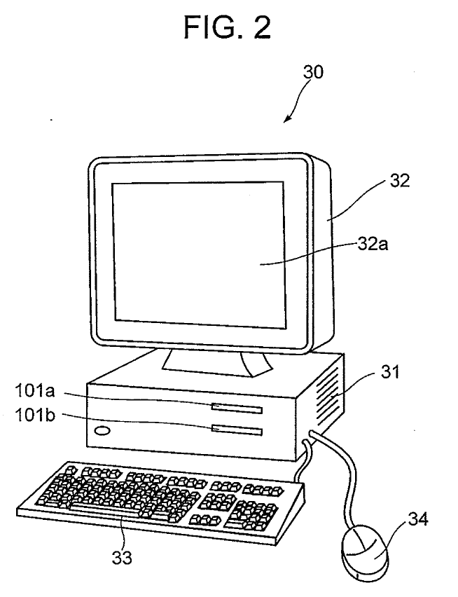

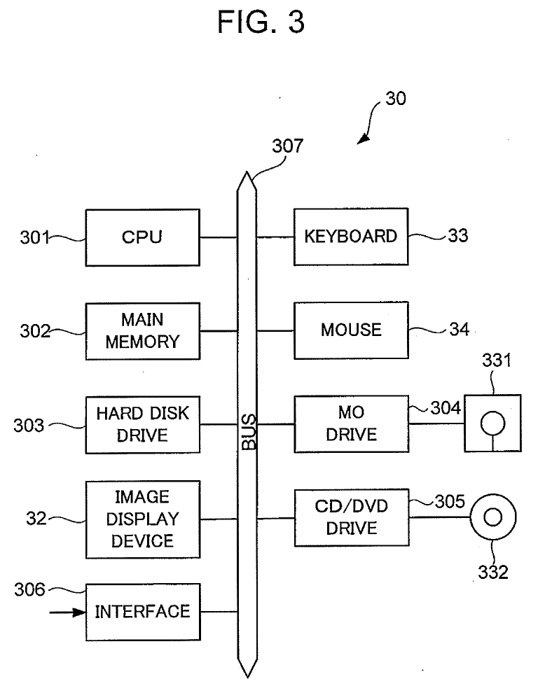

The detailed description of the monitoring camera 10 is omitted because the monitoring camera 10 is not the main subject of the invention, and the personal computer 30 that is operated as the head detecting apparatus of the embodiment of the invention will be described below. FIG. 2 is a perspective view showing an appearance of the personal computer 30 shown by one block of FIG. 1, and FIG. 3 shows a hardware configuration of the personal computer 30.

The head detecting apparatus as the embodiment of the invention is formed by the hardware and OS (Operating System) of the personal computer 30 and a head detecting program which is installed in and executed by the personal computer 30.

Outwardly, the personal computer 30 is equipped with a main body 31, an image display device 32, a keyboard 33, and a mouse 34. The image display device 32 displays images on a display screen 32a according to an instruction provided from the main body 31. The keyboard 33 feeds various pieces of information into the main body 31 according to a key manipulation. The mouse 34 specifies an arbitrary position on the display screen 32a to feed an instruction corresponding to an icon displayed at the position at that time. From the appearance, the main body 31 includes a MO loading port 31a through which a magneto-optical disk (MO) is loaded and a CD/DVD loading port 31b through which CD or DVD is loaded.

As shown in FIG. 3, the main body 31 includes a CPU 301, a main memory 302, a hard disk drive 303, an MO drive 304, a CD/DVD drive 305, and an interface 306. The CPU 301 executes various programs. In the main memory 302, a program stored in the hard disk drive 303 is read and expanded to be executed in the CPU 301. The various programs and pieces of data are stored in the hard disk drive 303. The MO 331 is loaded in the MO drive 304, and the MO drive 304 accesses the loaded MO 331. A CD or DVD (in this cases, CD and DVD are referred to as CD/DVD while not distinguished from each other) is loaded in the CD/DVD drive 305, and the CD/DVD drive 305 accesses the CD/DVD 332. The interface 306 is connected to the Internet 20 of FIG. 1 to receive the image data taken by the monitoring camera 10. The components of FIG. 3 and the image display device 32, keyboard 33, and mouse 34 of FIG. 2 are connected through a bus 307.

A head detecting program is stored in the CD/DVD 332 to operate the personal computer as the head detecting apparatus. The CD/DVD 332 is loaded in the CD/DVD drive 305, and the head detecting program stored in the CD/DVD 332 is uploaded in the personal computer 30 and stored in the hard disk drive 303. The head detecting program stored in the hard disk drive 303 is read from the hard disk drive 303, and the head detecting program is expanded on the main memory 302 and executed by the CPU 301, thereby operating the personal computer 30 as the head detecting apparatus.

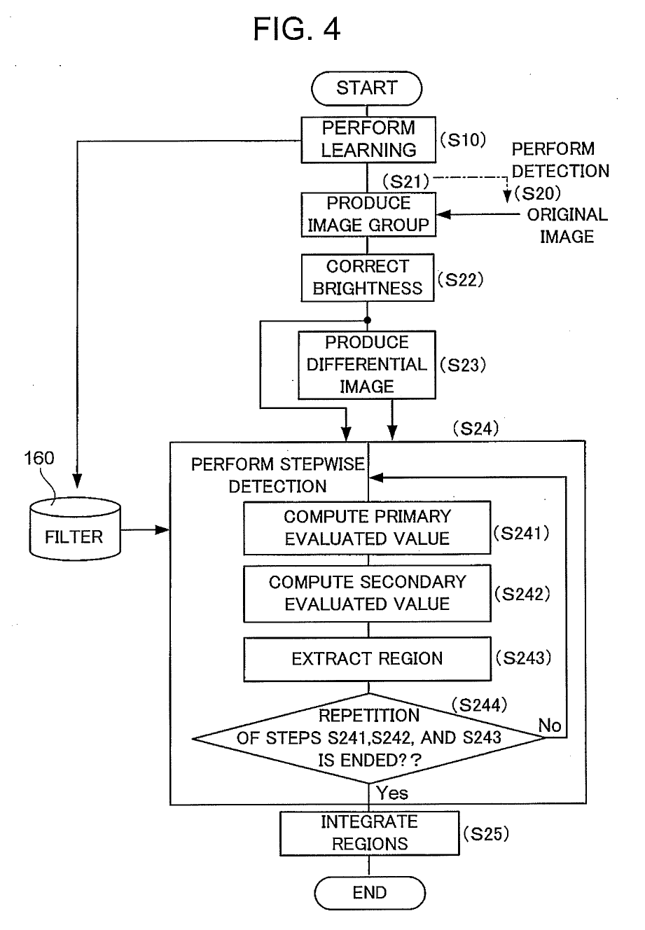

In addition to the head detecting program, various support programs are also stored in the hard disk drive 303 to perform a learning step S10 of FIG. 4. Examples of various programs include an image processing program and a program for performing machine learning described below to extract a filter. The image processing program is used to perform various pieces of image processing to the image. In the image processing, the image is displayed on the display screen 32a of the image display device 32, the magnification of the image is independently changed in vertical and horizontal directions according to a manipulation of an operator, and the image is rotated or partially cut out according to the manipulation of the operator.

FIG. 4 is a flowchart showing an example of a head detecting method performed with the personal computer 30 of FIGS. 1 to 3.

The head detecting method of FIG. 4 includes the learning step S10 and a detection step S20. The detection step S20 includes a set of steps S21 to S24 except for the learning step S10. The learning step S10 is a step of preparing the detection step S20. In the learning step S10, machine learning (for example, learning with an algorithm of Aba Boosting) is performed using a huge number of images, various filters acting on the original image of the head detecting target in the detection step S20 are extracted. The detailed description of learning step S10 is described later.

The detection step S20 is a step of automatically detecting the person's head from an original image of the detecting target using various filters extracted in the learning step S10. The detection step S20 includes an image group producing step S21, a brightness correction step S22, a differential image producing step S23, a stepwise detection step S24, and a region integrating step S25. The stepwise detection step S24 includes a primary evaluated value computing step S241, a secondary evaluated value computing step S242, a region extracting step S243, and a determination step S244. A determination whether or not the repetition of the steps S241, S242, and S243 is ended is made in determination step S244. The steps constituting the detection step S20 are described in detail later.

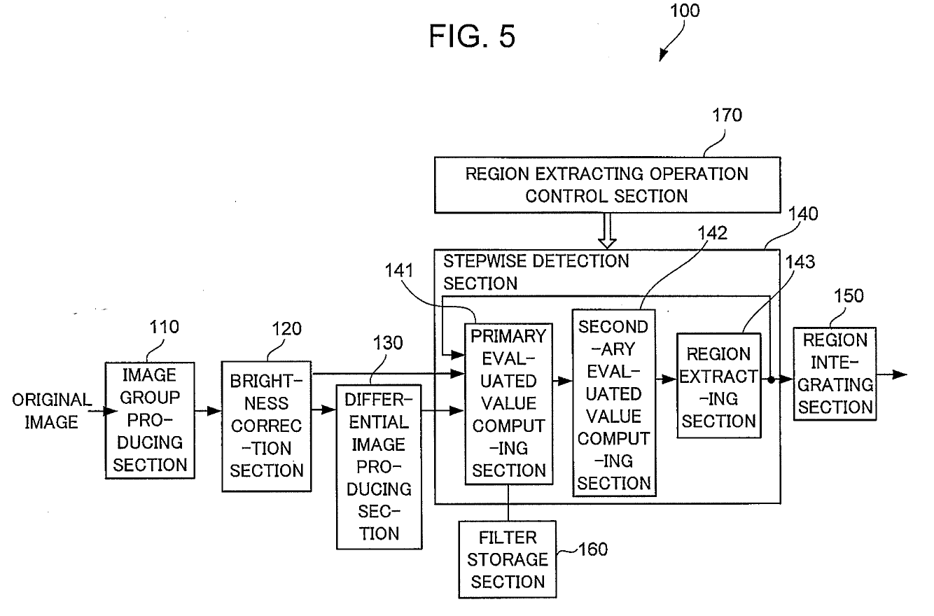

FIG. 5 is a block diagram showing an example of the head detecting apparatus. A head detecting apparatus 100 is an algorithm which is realized in the personal computer 30 by executing the head detecting program uploaded in the personal computer 30 of FIGS. 1 to 3. The head detecting apparatus 100 includes an image group producing section 110, a brightness correction section 120, a differential image producing section 130, a stepwise detection section 140, a region integrating section 150, a filter storage section 160, and a region extracting operation control section 170. The stepwise detection section 140 includes a primary evaluated value computing section 141, a secondary evaluated value computing section 142, and a region extracting section 143.

In comparison with the head detecting method of FIG. 4, the whole of the head detecting apparatus 100 of FIG. 5 corresponds to the detection step S20 in the head detecting method of FIG. 4, the image group producing section 110 corresponds to the image group producing step S21, the brightness correction section 120 corresponds to the brightness correction step S22, the differential image producing section 130 corresponds to the differential image producing step S23, combination of the stepwise detection section 140 and the region extracting operation control section 170 corresponds to the stepwise detection step S24, and the region integrating section 150 corresponds to the region integrating step S25. Various filters (described later) extracted in the learning step S10 are stored in the filter storage section 160 also shown in FIG. 4.

The primary evaluated value computing section 141, secondary evaluated value computing section 142, and region extracting section 143 constituting the stepwise detection section 140 correspond to the primary evaluated value computing step S241, secondary evaluated value computing step S242, and region extracting step S243 constituting the stepwise detection step S24 in the head detecting method of FIG. 4, respectively. The region extracting operation control section 170 corresponds to the determination step S244 constituting the stepwise detection step S24.

Because the action of the head detecting program executed in the personal computer 30 is identical to that of the head detecting apparatus shown in FIG. 5, the illustration and description of the head detecting program are not repeated here.

The action of each component in the head detecting apparatus 100 of FIG. 5 will generally be described below. The description of the action of each component in the head detecting apparatus 100 also serves as the descriptions of the head detecting program and the steps constituting the detection step S20 in the head detecting method of FIG. 4. Then the learning step S10 in the head detecting method of FIG. 4 and the head detecting apparatus will specifically be described.

The head detecting apparatus 100 of FIG. 5 detects the person's head from the image expressed by two-dimensionally arrayed pixels.

Many filters extracted in the learning step S10 of the head detecting method shown in FIG. 4 are stored in the filter storage section 160. The filters act on a region having a predetermined size two-dimensionally spread on the image, and the filters compute the person's head outline and one of person's head feature quantities different from one another. Each of the filters is stored in the filter storage section while correlated with a correspondence relationship between a feature quantity computed by each filter and a primary evaluated value indicating a probability of the person's head. Each of the filters includes plural filters in each of plural sizes acting on the regions having plural sizes (in this case, 32-by-32 pixel, 16-by-16 pixel, and 8-by-8 pixel). In the plural sizes, the number of pixels corresponding to the size of the region on the image is changed in a stepwise manner with a ratio of 1/2 in each of the vertical and horizontal directions.

In the image group producing section 110, the pixels constituting the fed original image are gradually thinned out vertically and horizontally with the ratio of 1/2 to produce an image group including the original image and several thinned-out images. In the image group producing section 110, in addition to the image group produced by thinning out the original image with the ratio of 1/2, an interpolated image constituting an image group including the original image is produced by performing interpolation operation to the original image. The number of pixels of the interpolated image is larger than that of the thinned-out image obtained by vertically and horizontally thinning out the original image with the ratio of 1/2 (the number of pixels becomes a quarter (the ratio of 1/2 in each of the vertical and horizontal directions)) of that of the original image, and number of pixels of the interpolated image is smaller than that of the original image. The pixels constituting the produced interpolated image are gradually thinned out vertically and horizontally with the ratio of 1/2 to produce a new image group including the interpolated image and the thinned-out image obtained by thinning out the pixels of the interpolated image.

The brightness correction section 120 performs brightness correction processing. In the brightness correction processing, when attention focuses on one pixel on the image, a pixel value (brightness value) of the focused pixel is corrected using an average value and a variance of the pixel values (brightness values) of the plural pixels existing in a certain region including the focused pixel. The brightness correction processing is performed to the whole image while each pixel on the image is set as the focused pixel. The brightness correction processing is performed to each image constituting the image group received from the image group producing section 110.

The brightness correction processing performed by the brightness correction section 120 effectively improves accuracy of the head detection when the image in which the brightness heavily depends on the pixel is set as the head detecting target. Although the head detecting apparatus 100 of the embodiment includes the brightness correction section 120, it is not always necessary to perform the brightness correction processing in the invention.

The moving image is fed from the monitoring camera 10 of FIG. 1 into the differential image producing section 130. The differential image producing section 130 produces a differential image of adjacent frame, and the differential image producing section 130 transfers the differential image to the stepwise detection section 130.

The image in which the brightness is already corrected by the brightness correction section 120 is directly fed into the stepwise detection section 140. The image in which the brightness is already corrected by the brightness correction section 120 is also fed into the differential image producing section 130, and the differential image produced by the differential image producing section 130 is fed into the stepwise detection section 140. This is because the movement information on the person's head is used to detect the head with high accuracy by utilizing not only the one-by-one still image but also the differential image as the head detecting target image.

In the stepwise detection section 140, the primary evaluated value computing section 141 applies plural filters to each region on the head detecting target image to compute plural feature quantities, and the primary evaluated value computing section 141 obtains a primary evaluated value corresponding to each feature quantity based on the correspondence relationship (between the feature quantity computed by the filter and the primary evaluated value indicating the probability of the person's head) correlated with each filter. Then the secondary evaluated value computing section 142 puts together the plural primary evaluated values corresponding to the plural filters obtained by the primary evaluated value computing section 141 using an operation such as addition and computation of the average value, thereby obtaining the secondary evaluated value indicating the existing probability of the person's head in the region. Then the region extracting section 143 compares the secondary evaluated value obtained by the secondary evaluated value computing section 142 and the threshold to extract the region where the existing probability of the person's head is higher than the threshold. In the head detecting apparatus 100 of FIG. 5, the person's head is detected by extracting the region with the region extracting section 143.

In the stepwise detection section 140, under the sequence control of the region extracting operation control section 170, the primary evaluated value computing section 141, the secondary evaluated value computing section 142, and the region extracting section 143 are repeatedly operated, and the region where the person's head appears is extracted with the extremely high probability. The region extracting operation control section 170 controls the operations of the primary evaluated value computing section 141, secondary evaluated value computing section 142, and region extracting section 143 constituting the stepwise detection section 140 as follows.

The region extracting operation control section 170 causes the operations of the primary evaluated value computing section 141, secondary evaluated value computing section 142, and region extracting section 143 to perform a first extraction process. That is, the region extracting operation control section 170 causes the primary evaluated value computing section 141 to apply plural first filters acting on a relatively narrow region in many filters stored in the filter storage section 160 to a relatively small first image in the image group produced by the image group producing section 110 to compute plural feature quantities, and the region extracting operation control section 170 causes the primary evaluated value computing section 141 to obtain the primary evaluated value corresponding to each feature quantity based on the correspondence relationship. The region extracting operation control section 170 causes the secondary evaluated value computing section 142 to put together the plural primary evaluated values corresponding to the plural first filters, obtained by the primary evaluated value computing section 141, thereby causing the secondary evaluated value computing section 142 to obtain the secondary evaluated value indicating the existing probability of the person's head in the region. The region extracting operation control section 170 causes the region extracting section 143 to compare the secondary evaluated value obtained by the secondary evaluated value computing section 142 and a first threshold to extract a primary candidate region where the existing probability of the person's head is higher than the first threshold.

Then the region extracting operation control section 170 causes the operations of the primary evaluated value computing section 141, secondary evaluated value computing section 142, and region extracting section 143 to perform a second extraction process. That is, the region extracting operation control section 170 causes the primary evaluated value computing section 141 to compute plural feature quantities by applying plural second filters acting on a region wider by one stage than that of the plural first filters in many filters stored in the filter storage section 160 to a region corresponding to a primary candidate region of the second image where the number of pixels is larger than by one stage than that of the first image in the image group produced by the image group producing section 110, and the region extracting operation control section 170 causes the primary evaluated value computing section 141 to obtain the primary evaluated value corresponding to each feature quantity based on the correspondence relationship. The region extracting operation control section 170 causes the secondary evaluated value computing section 142 to put together the plural primary evaluated values corresponding to the plural second filters, obtained by the primary evaluated value computing section 141, thereby causing the secondary evaluated value computing section 142 to obtain the secondary evaluated value indicating the existing probability of the person's head in the primary candidate region. The region extracting operation control section 170 causes the region extracting section 143 to compare the secondary evaluated value obtained by the secondary evaluated value computing section 142 and a second threshold to extract a secondary candidate region where the existing probability of the person's head is higher than the second threshold.

The region extracting operation control section 170 causes the primary evaluated value computing section 141, secondary evaluated value computing section 142, and region extracting section 143 to sequentially repeat the plural extraction processes including the first extraction process and the second extraction process from the extraction process of applying the filter acting on the relatively narrow region to the relatively small image toward the extraction process of applying the filter acting on the relatively wide region to the relatively large image.

In the head detecting apparatus 100 of FIG. 5, the region extracting section 143 finally extracts the region by the repetition, thereby detecting the person's head with high accuracy.

As described above, in the image group producing section 110, the plural image groups are produced from one original image by the interpolation operation and the thinning-out operation. For each of the plural image groups (the image group of the differential images is produced by the differential image producing section 130, and the plural image groups includes the image group of the differential images produced by the differential image producing section 130) produced by the image group producing section 110, the region extracting operation control section 170 causes the primary evaluated value computing section 141, secondary evaluated value computing section 142, and region extracting section 143 to sequentially repeat the plural extraction processes from the extraction process of applying the filter acting on the relatively narrow region to the relatively small image toward the extraction process of applying the filter acting on the relatively wide region to the relatively large image.

Therefore, the person's heads having various sizes can be detected.

Sometimes both a first region and a second region are extracted as the person's head region from the region extracting section 143. The first region includes the person's face in the substantial center of the image. The second region includes the head including the hair of the same person in the substantial center of the same image. In the second region, compared with the first region, the head partially overlaps another item while the head is separated from another item. Therefore, in such cases, the head detecting apparatus 100 of FIG. 5 includes the region integrating section 150 to perform processing for integrating the plural regions into one region. Specifically, in cases where the plural regions are detected by the region extracting section 143, the plural regions are integrated into one region according to a degree of the overlap between the plural regions. The detailed description is made later.

The embodiments of the invention will be described more specifically below.

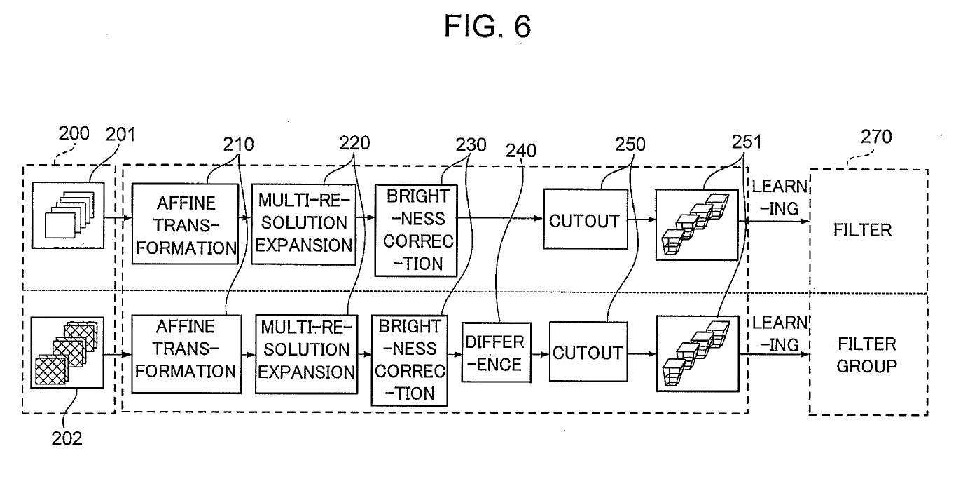

FIG. 6 is a detailed flowchart showing the learning step S10 in the head detecting method of FIG. 4.

FIG. 6 shows two flowcharts, the flowchart in the upper stage shows processing for dealing with one-by-one still image before the difference is computed, and the flowchart in the lower stage shows processing for dealing with the differential image.

First, many images 200 are prepared to produce a teacher image. The many images 200 include many still images 201 and moving images 202 for producing the differential image. Each image constituting the moving images 202 may be used as the still image 201. Preferably the images 200 are obtained by the monitoring camera 10 (see FIG. 1) which takes the head detecting original image. The images 200 are not limited to the images obtained by the monitoring camera 10. For example, instead of the images taken by the monitoring camera 10, the image 200 may be obtained by collecting the images in various scenes in which persons exist and the images in various scenes in which persons do not exist.

Affine transform processing 210, multi-resolution expansion processing 220, and brightness correction processing 230 are sequentially performed to the images 200, and the differential image is produced from the moving image 202 through differential operation processing 240. Then a teacher image 251 is produced through cutout processing 250. The teacher image 251 is formed by a teacher image group for each scene. The teacher image group includes a 32-by-32-pixel teacher image, a 16-by-16-pixel teacher image, and an 8-by-8-pixel teacher image. The teacher image group is produced for each of many scenes.

The affine transform processing 210, the multi-resolution expansion processing 220, the brightness correction processing 230, the differential operation processing 240, and the cutout processing 250 will be described below.

In the affine transform processing 210, many images are produced by changing one image little by little instead of the collection of extremely many images, thereby increasing the number of images which becomes the basis of the teacher image. At this point, the images are produced by inclining the one original image by −12°, −6°, 0°, +6°, and +12°. Additionally, the images are produced by vertically scaling the original image by 1.2 times, 1.0 time, and 0.8 time, and the images are produced by horizontally scaling the original image by 1.2 times, 1.0 time, and 0.8 time. In the produced images, the image having the inclination of 0°, the vertical scale factor of 1.0 time, and the horizontal scale factor of 1.0 time is the original image. The 45(=5×3×3) images including the original image are produced from the one original image by a combination of the inclination and the scaling. Therefore, a great number of teacher images are produced, which enables the high-accuracy learning.

The multi-resolution expansion processing 220 will be described below.

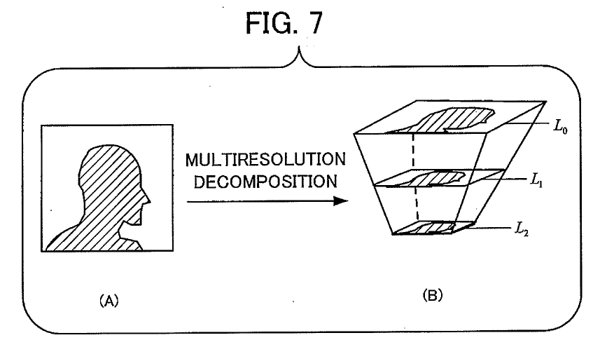

FIG. 7 is an explanatory view of the multi-resolution expansion processing.

The person's head appears in FIG. 7 and the teacher image is already obtained. However, in the multi-resolution expansion processing 220 of FIG. 6, the following processing is performed to the whole of the image before the image is cut out as the teacher image.

Assuming that Lo is the one original image shown in part (A) of FIG. 7, an image L₁ which is vertically and horizontally reduced into ½ (¼ in area) is produced by vertically and horizontally thinning out every other pixel from the original image Lo. Similarly an image L₂ which is vertically and horizontally reduced into ½ (¼ in area) is produced by vertically and horizontally thinning out every other pixel from the image L₁. Part (B) of FIG. 7 shows an image group produced in the above-described manner in an inverted pyramid structure, the image group includes three images Lo, L₁, and L₂.

Then the brightness correction processing 230 is performed.

In the brightness correction processing 230, the pixel value (brightness value) after the correction is obtained by the following equation (1). Where X_{org} is a pixel value (brightness value) of a pixel X before the correction, X_{cor} is brightness after the correction.

$${X}_{cor} = \frac{{X}_{org} - E ( {X}_{org} )}{σ ( {X}_{org} )} \qquad ( 1 )$$

E(X_{org}) and σ(X_{org}) are an average value and a variance of the pixel value (brightness value) in the neighborhood (for example, 9-by-9 pixel) of the pixel X. The brightness correction is performed by performing the brightness correction processing 230 to the whole of the image.

The brightness correction is performed to each of the three-layer images Lo, L₁, and L₂ shown in part (B) of FIG. 7. That is, the brightness correction is performed to the image L₂ in the lower layer using the scene of the region which is wider than that of the original image.

Then the differential processing 240 is performed to the moving image.

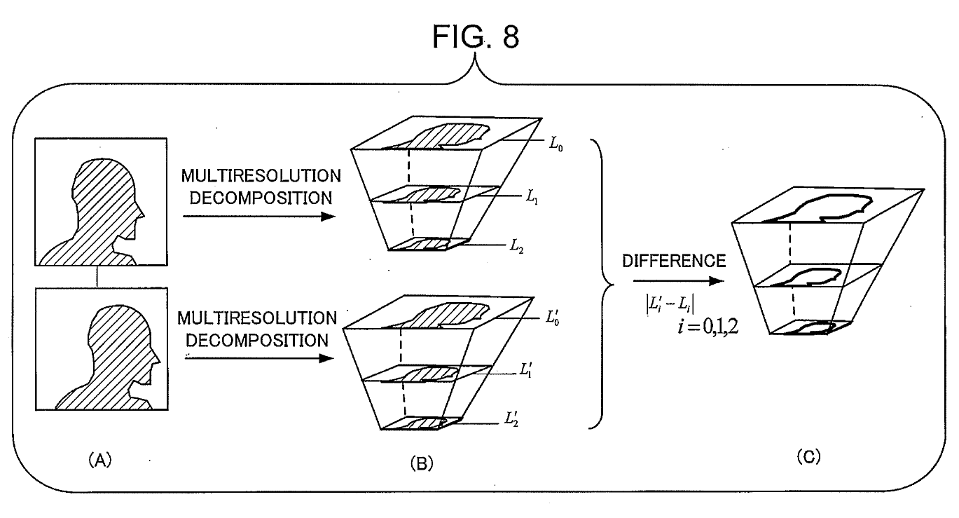

FIG. 8 is an explanatory view of the moving image differential processing.

Part (A) of FIG. 8 shows the images of two frames adjacent to each other in the moving image. Two image group which include images Lo, L₁, and L₂ and images Lo′, L₁′, and L₂′ respectively are produced from the two images through the multi-resolution expansion processing 220 (part (B) of FIG. 8).

The brightness correction processing 230 is performed to the images Lo, L₁, and L₂ and images Lo′, L₁′, and L₂′ constituting the two image groups, and the differential processing 240 is performed to the images Lo, L₁, and L₂ and images Lo′, L₁′, and L₂′.

In the differential processing 240, an absolute value (|Lᵢ′−Lᵢ|, i=0, 1, and 2) of the differential value in each corresponding pixel is obtained for the images having the same size, and the inverted-pyramid-shape image group including the three differential images shown in part (C) of FIG. 8 is produced.

Then the cutout processing is performed.

In the cutout processing 250, the region where the person's head in various modes appears or the region where the subject except for the person's head appears is cut out from the image having the three-layer structure shown in part (B) of FIG. 7 and part (C) of FIG. 8, the a teacher image that the person's head exists is produced from the region where the person's head appears, and a teacher image that the person's head does not exist is produced from the region where the subject except for the person's head appears.

In cutting out the teacher image, the 32-by-32-pixel region is cut out as the teacher image from the uppermost-layer image in the three-layer images shown in part (B) of FIG. 7 and part (C) of FIG. 8, the 16-by-16-pixel region of the same portion is cut out from the second-layer image, and the 8-by-8-pixel region of the same portion is cut out from the third-layer image. The cut-out three-layer teacher images differ from one another in resolution because of the different image sizes. However, the three-layer teacher images are cut out from the same portion on the image. Accordingly, the teacher images also become the inverted-pyramid-shape teacher image group having the three-layer structure shown in part (B) of FIG. 7 and part (C) of FIG. 8.

The many teacher image groups 251 having the three-layer structures are produced and used for the learning.

The filter on the side in which the learning is performed by the teacher images will be described.

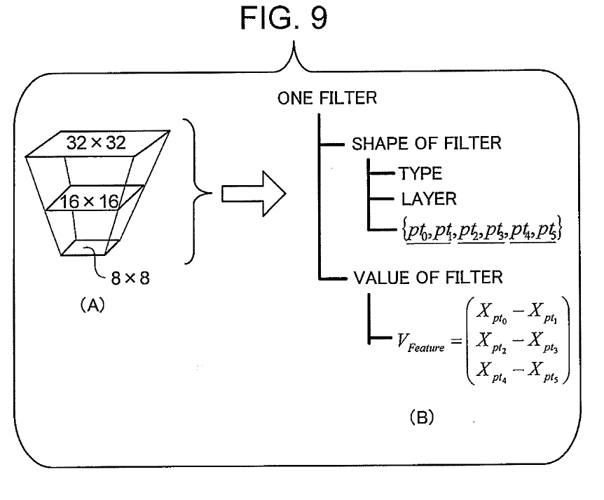

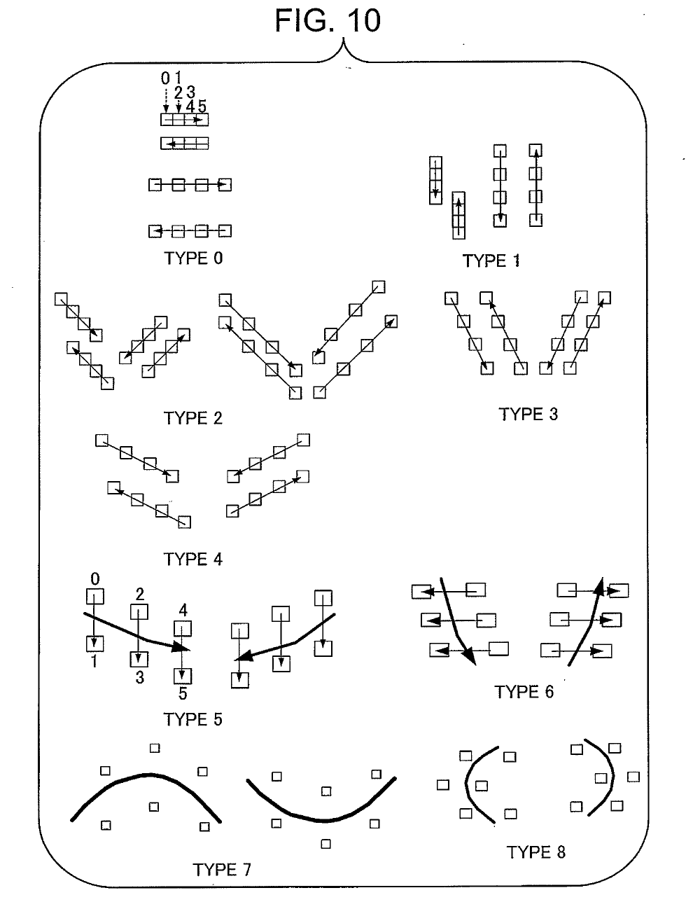

FIG. 9 is an explanatory view of a filter structure, and FIG. 10 illustrates various filters.

At this point, various kinds of filters are prepared. The filters are divided into the filter acting on the 32-by-32-pixel region on the image, the filter acting on the 16-by-16-pixel region on the image, and the filter acting on the 8-by-8-pixel region on the image. The filters are a filter candidate used to detect the head until the filter is extracted by the learning. In the filter candidates, the filter candidate acting on the 32-by-32-pixel region is selected by the learning performed using the 32-by-32-pixel teacher image in the teacher image group having the three-layer structure shown in part (A) of FIG. 9, and the filter which should be used to detect the head is extracted. Similarly, the filter candidate acting on the 16-by-16-pixel region in the many filter candidates is selected by the learning performed using the 16-by-16-pixel teacher image in the teacher image group having the three-layer structure, and the filter which should be used to detect the head is extracted. Similarly, the filter candidate acting on the 8-by-8-pixel region in the many filter candidates is selected by the learning performed using the 8-by-8-pixel teacher image in the teacher image group having the three-layer structure, and the filter which should be used to detect the head is extracted.

As shown in part (B) of FIG. 9, one filter has attributes of a type, a layer, and six pixel coordinates {pto, pt1, pt2, pt3, pt4, and pt5}. Assuming that Xₚₜₒ, Xₚₜ₁, Xₚₜ₂, Xₚₜ₃, Xₚₜ₄, and Xₚₜ₅ are pixel values (brightness values) of the pixels located at the six pixel coordinates, vectors of three differential values are computed by the following operation.

$${V}_{Feature} = ( \begin{matrix}{X}_{{pt}_{0}} - {X}_{{pt}_{1}} \\ {X}_{{pt}_{2}} - {X}_{{pt}_{3}} \\ {X}_{{pt}_{4}} - {X}_{{pt}_{5}}\end{matrix} ) \qquad ( 2 )$$

The “type” indicates a large classification such as type 0 to type 8 shown in FIG. 10. For example, type 0 on the upper left of FIG. 10 indicates a filter which computes the difference in the horizontal direction (θ=0°), type 1 indicates a filter which computes the difference in the vertical direction (θ=±90°), and types 2 to 4 indicate filters which compute the difference in the direction of each type. Types 5 to 8 indicate filters which detect an edge of each curved line by the differential operation shown in FIG. 10. The “layer” is an identification marker indicating which the filter acting on the 32-by-32-pixel region, the filter acting on the 16-by-16-pixel region, or the filter acting on the 8-by-8-pixel region.

The six pixel coordinates {pto, pt1, pt2, pt3, pt4, and pt5} designates coordinates of the six pixels in the 64(=8×8) pixels in cases where the filter acts on the 8-by-8-pixel region. The same holds true for the filter acting on the 16-by-16-pixel region and the pixel acting on the 32-by-32-pixel region.

The operation performed using the equation (2) is performed to the six pixels designated by the six pixel coordinates {pt0, pt1, pt2, pt3, pt4, and pt5}. For example, in the case of the top filter in the type 0 on the upper left of FIG. 10, assuming that Xo is a brightness value of the pixel to which the numerical value of 0 is appended, X₁ is a brightness value of the pixel to which the numerical value of 1 is appended, X₂(=X₁) is a brightness value of the pixel (at this point, the pixel to which the numerical value of 2 is appended is identical to the pixel to which the numerical value of 1 is appended) to which the numerical value of 2 is appended, X₃ is a brightness value of the pixel to which the numerical value of 3 is appended, X₄(=X₃) is a brightness value of the pixel (at this point, the pixel to which the numerical value of 4 is appended is identical to the pixel to which the numerical value of 1 is appended) to which the numerical value of 4 is appended, and X₅ is a brightness value of the pixel to which the numerical value of 5 is appended, the following equation (3) is obtained.

$${V}_{Feature} = ( \begin{matrix}{X}_{0} - {X}_{1} \\ {X}_{2} - {X}_{3} \\ {X}_{4} - {X}_{5}\end{matrix} ) \qquad ( 3 )$$

The numerical values of 0 to 5 are appended to the filters on the left side of the type 5, and the operation similar to that of the equation (3) is performed.

In the various filters of FIG. 10, the operations similar to that of the type 0 or type 5 are performed.

As shown in FIG. 6, when the teacher image group 251 is produced, a filter 270 used to detect the head is extracted from many filter candidates by the machine learning.

The machine learning will be described below.

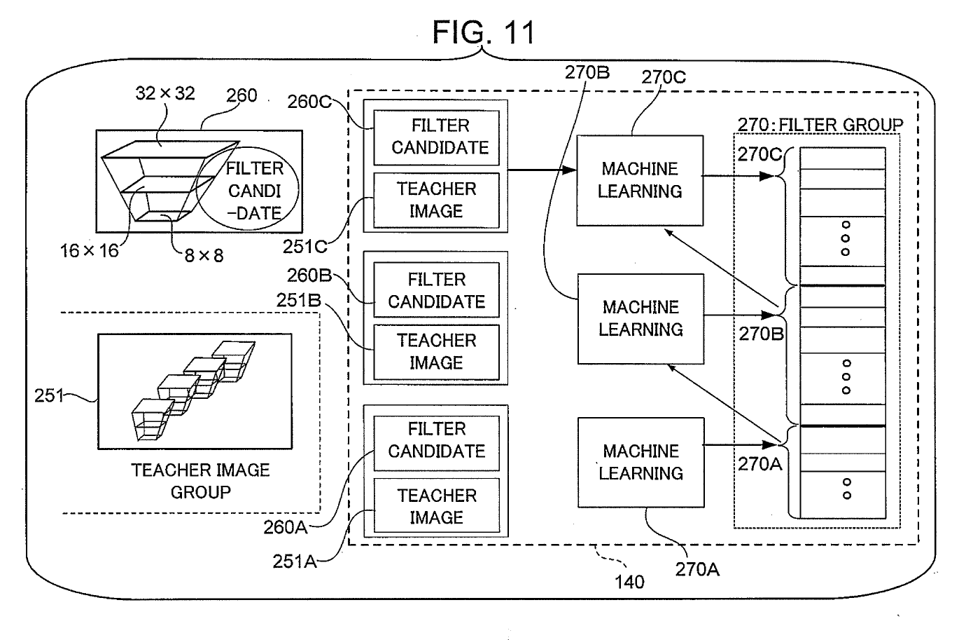

FIG. 11 is a conceptual view of the machine learning.

As described above, many filter candidates 260 are prepared while the many teacher image groups 251 are prepared, a filter 270A used to detect the head is extracted from filter candidates 260A acting on the 8-by-8-pixel region using many 8-by-8-pixel teacher images 251A in the teacher image groups 251. Then, while the extraction result is reflected, a filter 270B used to detect the head is extracted from filter candidates 260B acting on the 16-by-16-pixel region using many 16-by-16-pixel teacher images 251B. Then, while the extraction result is reflected, a filter 270C used to detect the head is extracted from filter candidates 260B acting on the 32-by-32-pixel region using many 32-by-32-pixel teacher images 251C.

At this point, the Aba Boost algorithm is adopted as an example of the machine learning. Because the Aba Boost algorithm is already adopted in the wide fields, the Aba Boost algorithm will simply be described below.

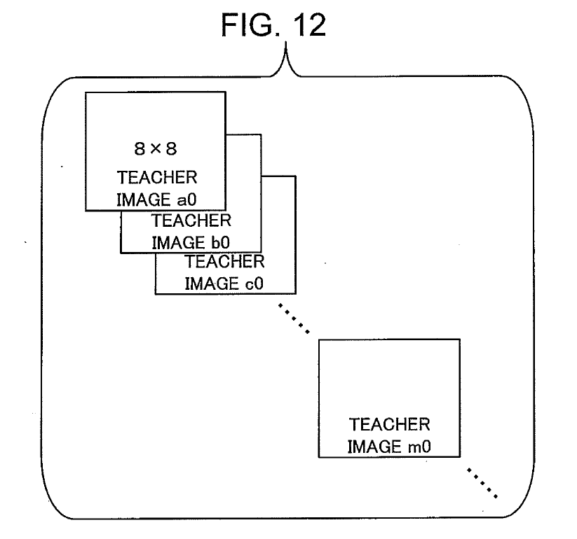

FIG. 12 is a conceptual view of the teacher image.

At this point, it is assumed that 8-by-8-pixel many teacher images a0, b0, c0, . . . , and m0 are prepared. The teacher images include the teacher image which is of the head and the teacher image which is not of the head.

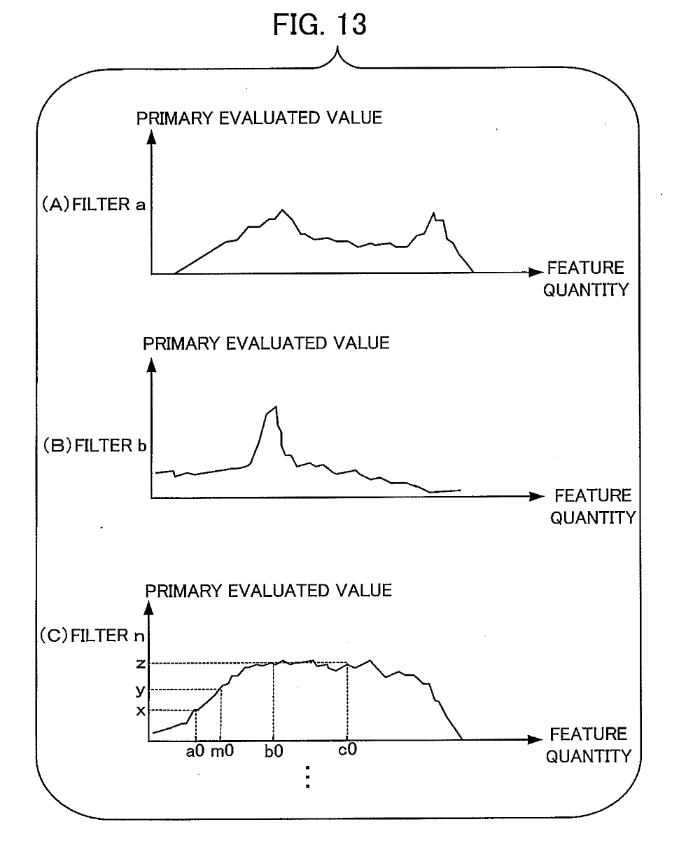

FIG. 13 is a conceptual view showing various filters and learning results of the filters.

In such cases, various filters (in this stage, filter candidate) a, b, . . . , and n acting on the 8-by-8-pixel region are prepared, and the learning is performed to each of the filters a, b, . . . , and n using the many teacher images of FIG. 12.

Each graph of FIG. 13 shows the learning result for each filter.

A feature quantity including a three-dimensional vector expressed by the equation (2) is computed in each filter. For the sake of convenience, the feature quantity is shown as a one-dimensional feature quantity.

In the graphs of FIG. 13, a horizontal axis indicates the value of the feature quantity obtained for each of the many teacher images using the filter, and a vertical axis indicates percentage of correct answer on the head using the filter. The probability is used as the primary evaluated value.

It is assumed that, as a result of performing the first learning to each of the filters a, b, . . . , and n, the learning result is obtained as shown in FIG. 13 and the percentage of correct answer becomes the maximum when the filter n is used. In such cases, the filter n is used as the head detecting filter, and the second learning is performed to the filters a, b, . . . except for the filter n.

As shown in part (C) of FIG. 13, it is assumed that the primary evaluated values of x, y, z, and z are obtained for the teacher images a0, b0, c0, and m0.

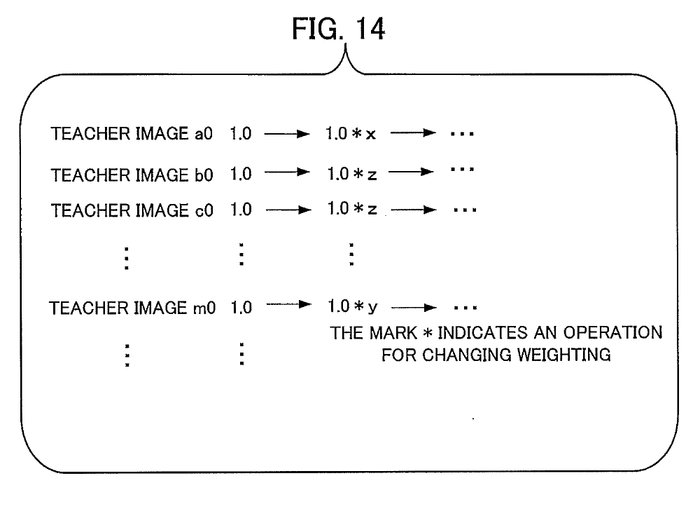

FIG. 14 is an explanatory view showing weighting the teacher image.

The first learning is performed to all the teacher images a0, b0, c0, . . . , and m0 with the same weight of 1.0. On the other hand, in the second learning, the probabilities of x, y, z, and z of the teacher images are added to the teacher images a0, b0, c0, . . . , and m0 by the filter n in which the maximum percentage of correct answer is obtained in the first learning, the weight is lowered for the teacher image having the high possibility of correct answer, and the weight is increased for the teacher image having the low possibility of correct answer. The weight is reflected on the percentage of correct answer of each teacher image in the second learning. That is, in the second learning, the weight is the same thing that each teacher image is repeatedly used for the learning by the number of times of the weight. In the second learning, the filter candidate in which the maximum percentage of correct answer is obtained is extracted as the head detecting filter. The weights for the teacher images a0, b0, c0, . . . , and m0 are corrected again using the graph of the percentage of correct answer on the feature quantity of the extracted filter, and the learning is performed to the remaining filters except for the currently extracted filter. The many head detecting filters 270A (see FIG. 11) acting on the 8-by-8-pixel region are extracted by repeating the learning.

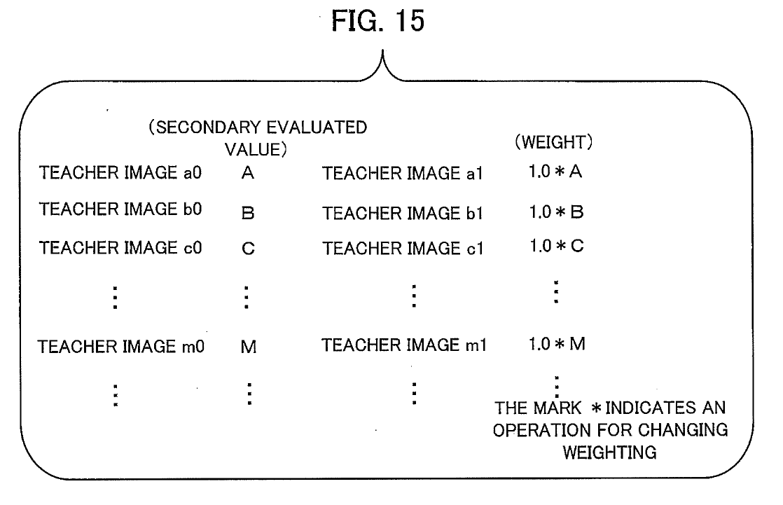

FIG. 15 is an explanatory view of a weighting method in making a transition to the learning of the 16-by-16-pixel filter after the 8-by-8-pixel filter is extracted.

After the 8-byb-8-pixel filter is extracted, the correspondence relationship (for example, the graph shown in FIG. 13) between the feature quantity and the primary evaluated value is obtained for the filters when each of the filters is independently used, and the secondary evaluated value is obtained for each teacher image (for example, the teacher image a0) by adding the primary evaluated value of each of the filters which are obtained from the feature quantities obtained by the many 8-by-8-pixel filters. As shown in FIG. 15, it is assumed that secondary evaluated values A, B, C, . . . , and M are obtained for the teacher images a0, b0, c0, . . . , and m0. At this point, the weights of the 16-by-16-pixel teacher images a1, b1, c1, and m1 corresponding to the 8-by-8-pixel teacher images a0, b0, c0, . . . , and m0 are changed from the weight of 1.0 which is equal to all the images using the secondary evaluated values A, B, C, . . . , and M, and the changed weights are used for learning to extract the filter acting on the 16-by-16-pixel region.

Hereinafter, the extraction algorithm for the filter of the 16-by-16-pixel region, the weighting changing algorithm, and the algorithm for making the transition to the extraction of the filter of the 32-by-32-pixel region are similar to those described above, so that the description is not repeated here.

Thus, the filter group 270 including the many filters 270A acting on the 8-by-8-pixel region, the many filters 270B acting on the 16-by-16-pixel region, and the many filters 270C acting on the 32-by-32-pixel region is extracted, the correspondence relationship (any one of a graph, a table, and a function formula) between the feature quantity (vector of the equation (2)) and the primary evaluated value is obtained for each filter, and the filter group 270 and the correspondence relationship are stored in the filter storage section 160 of FIGS. 4 and 5.

The head detecting processing with the filter stored in the filter storage section 160 will be described below.

In the image group producing section 110, brightness correction section 120, and differential image producing section 130 of FIG. 5, the same pieces of processing as those of the multi-resolution expansion processing 220, brightness correction processing 230, and differential operation processing 240 of FIG. 6 in the learning are performed. However, because the processing performed by the image group producing section 110 is slightly different from the multi-resolution expansion processing 220, the processing performed by the image group producing section 110 will be described below.

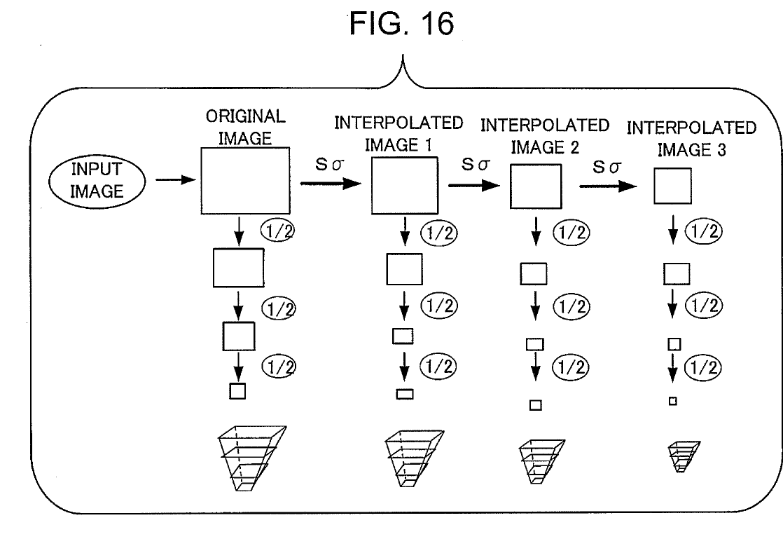

FIG. 16 is a schematic diagram showing the processing performed by the image group producing section 110 of FIG. 5.

The moving image taken by the monitoring camera 10 of FIG. 1 is fed into the image group producing section 110, and the processing of FIG. 16 is performed to each of the images constituting the moving image.

Interpolation operation processing is performed to the original image which is of the input image, an interpolated image 1 which is slightly smaller than the original image is obtained, and an interpolated image 2 which is slightly smaller than the interpolated image 1 is obtained. Similarly an interpolated image 3 is obtained.

A ratio Sσ of the image size between the original image and the interpolated image 1 is expressed for each of the vertical and horizontal directions by the following equation (4).

$$S σ = {2}^{- \frac{1}{N}} \qquad ( 4 )$$

Where N is the number of interpolated images including the original image (N=4 in the example of FIG. 16).

After the interpolated images (interpolated images 1, 2, and 3 in the example of FIG. 16) are produced, the images having the sizes of ½ in the vertical and horizontal directions are produced by thinning out every other pixel from the original image and interpolated images in the vertical and horizontal directions, the images having the sizes of ¼ in the vertical and horizontal directions are produced by thinning out every other pixel from the original image and interpolated images having the sizes of ½ in the vertical and horizontal directions, and the images having the sizes of ⅛ in the vertical and horizontal directions are produced by thinning out every other pixel from the original image and interpolated images having the sizes of ¼ in the vertical and horizontal directions. Therefore, in the example of FIG. 16, four inverted-pyramid-shape image groups having four layers are produced from the one original image.

The heads having various sizes can be extracted by producing the images having many sizes.

Because the pieces of processing performed by the brightness correction section 120 and differential image producing section 130 of FIG. 5 are similar to the brightness correction processing 230 and differential operation processing 240 of FIG. 6, the overlapping description is not repeated here.

After the brightness correction section 120 performs the brightness correction processing to the inverted-pyramid-shape image group of FIG. 16, the differential image producing section 130 converts the inverted-pyramid-shape image group of FIG. 16 into the inverted-pyramid-shape image group of the differential image, and the inverted-pyramid-shape image group of the differential image is fed into the stepwise detection section 140. The stepwise detection section 140 performs the following operation processing under the sequence control of the region extracting operation control section 170.

In the primary evaluated value computing section 141, the many filters acting on the 8-by-8-pixel region are read from the filter storage section 160, and the image having the smallest size and the image having the second smallest size in each four images constituting the inverted-pyramid-shape image group having the four layers shown in FIG. 16 are raster-scanned by the 8-by-8-pixel filters. Then a vector (see equation (2)) indicating the feature quantity is obtained in each of the sequentially moved regions, the correspondence relationship (see FIG. 13) between the feature quantity and the primary evaluated value is referred to in each filter, and the feature quantity is converted into the primary evaluated value.

In the secondary evaluated value computing section 142, the many primary evaluated values obtained by the many filters acting on the 8-by-8-pixel region are added to one another to obtain the secondary evaluated value. The region extracting section 143 extracts the primary extraction region in which the secondary evaluated value is equal to or larger than a predetermined first threshold (high probability of the appearance of the head).

Then the positional information on the primary extraction region is transmitted to the primary evaluated value computing section 141. In the primary evaluated value computing section 141, the many filters acting on the 16-by-16-pixel region are read from the filter storage section 160, each filter acting on the 16-by-16-pixel region is applied to the region corresponding to the primary extraction region extracted by the region extracting section 143, the feature quantity is computed on the second smallest image and the third smallest image (second largest image) for each of the four inverted-pyramid-shape image groups of FIG. 16, and the feature quantity is converted into the primary evaluated value. In the secondary evaluated value computing section 142, the many primary evaluated values obtained by the many filters acting on the 16-by-16-pixel region are added to one another to obtain the secondary evaluated value. The region extracting section 143 compares the obtained secondary evaluated value and the second threshold to extract the secondary extraction region where the probability of the appearance of the head is further enhanced from the region corresponding to the primary extraction region. The positional information on the secondary extraction region is transmitted to the primary evaluated value computing section 141. In the primary evaluated value computing section 141, the many filters acting on the 32-by-32-pixel region are read from the filter storage section 160, each filter acting on the 36-by-36-pixel region is applied to the region corresponding to the secondary extraction region extracted by the region extracting section 143, the feature quantity is extracted on the second largest image and the largest image for each of the four inverted-pyramid-shape image groups of FIG. 16, and the feature quantity is converted into the primary evaluated value. In the secondary evaluated value computing section 142, the many primary evaluated values obtained by the many filters acting on the 32-by-32-pixel region are added to one another to obtain the secondary evaluated value. The region extracting section 143 compares the obtained secondary evaluated value and the third threshold to extract the tertiary extraction region having certainty that the head appears from the region corresponding to the secondary extraction region. The information on the tertiary extraction region, that is, a position pos of the region on the image (coordinate (l,t) at the corner on the upper left of the region and a coordinate (r,b) in the corner on the lower right), and final secondary evaluated value likeness are fed into the region integrating section 150 of FIG. 5.

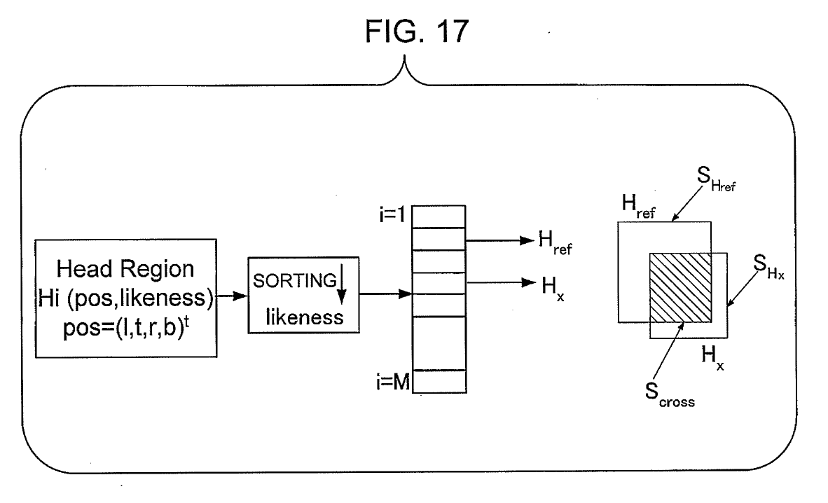

FIG. 17 is an explanatory view showing the region integrating processing performed by the region integrating section 150.

When pieces of information Hi (pos, likeness) on the plural head regions (tertiary extraction region) Hi (i=1, . . . , and M) are fed into the region integrating section 150, the region integrating section 150 sorts the pieces of head region information Hi in the order of the secondary evaluated value likeness. At this point, it is assumed that two regions Href and Hx partially overlap each other, and it is assumed that the region Href is higher than the region Hx in the secondary evaluated value likeness.

Assuming that SHref is an area of the region Href, SHx is an area of the region Hx, and Scross is an area of the overlapping portion of the regions Href and Hx, an overlapping ratio is computed by the following equation.

$$ρ = \frac{{S}_{cross}}{{S}_{Href} + {S}_{Hx} - {S}_{cross}} \qquad ( 5 )$$

A region integrating operation is performed when the overlapping ratio ρ is equal to or larger than a threshold ρlow. That is, the weight according to likeness in the region is imparted to the corresponding coordinate in the coordinates at the four corners of the region Href and the coordinates at the four corners of the region Hx, and the regions Href and Hx are integrated into one region.

For example, coordinates lref and lx in the horizontal direction at the upper left corners of the regions Href and Hx are converted into the integrated coordinate expressed by the following equation (6) using likeness(ref) and likeness(x) which are of the likeness of each of the regions Href and Hx.

$$l = \frac{{l}_{ref} \times likeness ( ref ) + {l}_{x} \times likeness ( x )}{likeness ( ref ) + likeness ( x )} \qquad ( 6 )$$

Using the equation (6), the operation is performed for the four coordinates pos=(l,t,r,b)^{t} which indicate the position, and the two regions Href and Hx is integrated into the one region.

The same holds true for the case in which at least three regions overlap one another.

In the embodiments, the region where the person's head appears is accurately extracted at high speed through the above-described pieces of processing.

What is claimed is:

1. An object detecting method which detects a specific kind of object from an image expressed by two-dimensionally arrayed pixels, the object detecting method comprising:
an image group producing step of producing an image group including an original image of an object detecting target and at least one thinned-out image by thinning out pixels constituting the original image at a predetermined rate or by thinning out the pixels at the predetermined rate in a stepwise manner; and
a stepwise detection step of detecting the specific kind of object from the original image by sequentially repeating a plurality of extraction processes from an extraction process of applying a filter acting on a relatively narrow region to a relatively small image toward an extraction process of applying a filter acting on a relatively wide region to a relatively large image,
the plurality of extraction processes including:
a first extraction process of extracting a primary candidate region where an evaluated value exceeding a predetermined first threshold is obtained by applying a first filter in a filter group including a plurality of filters to a relatively small first image in the image group produced in the image group producing step, the first filter acting on a relatively narrow region, each of the plurality of filters acting on a region two-dimensionally spread on the image to produce an evaluated value, the evaluated value indicating an existing probability of the specific kind of object in the region, the plurality of filters acting on regions having a plurality of sizes respectively, the number of pixels corresponding to the size of the region on the image being changed at the predetermined rate or changed at the predetermined rate in the stepwise manner in the plurality of sizes; and
a second extraction process of extracting a secondary candidate region where an evaluated value exceeding a predetermined second threshold is obtained by applying a second filter in the filter group to a region corresponding to the primary candidate region in a second image in which the number of pixels is larger than that of the first image in the image group produced in the image group producing step, the second filter acting on a region wider than that of the first filter.

2. The object detecting method according to claim 1, wherein the image group producing step is a step of performing an interpolation operation to the original image to produce one interpolated image or a plurality of interpolated images, in addition to the image group, the one interpolated image or the plurality of interpolated images constituting the image group, the number of pixels of the one interpolated image being in a range where the number of pixels is larger than that of the thinned-out image obtained by thinning out the original image at the predetermined rate and smaller than that of the original image, the plurality of interpolated images having the numbers of pixels which are different from one another within the range, and of producing a new image group by thinning out pixels constituting the interpolated image at the predetermined rate for each of the produced at least one interpolated image or by thinning out pixels at the predetermined rate in the stepwise manner, the new image group including the interpolated image and at least one thinned-out image obtained by thinning out the pixel of the interpolated image, and
the stepwise detection step is a step of detecting the specific kind of object from each of the original image and the at least one interpolated image by sequentially repeating the extraction processes to each of the plurality of image groups produced in the image group producing step from the extraction process of applying the filter acting on the relatively narrow region to the relatively small image toward the extraction process of applying the filter acting on a relatively wide region to the relatively large image.

3. The object detecting method according to claim 1, wherein a plurality of kinds of filters are prepared for each region having one size, each of the plurality of kinds of filters computing an outline of the specific kind of object and one of feature quantities in the specific kind of object,
a correlation between the feature quantity and a primary evaluated value is prepared, the feature quantity being computed by each filter, the primary evaluated value indicating a probability of the specific kind of object, and
the stepwise detection step is a step of computing the plurality of feature quantities by applying the plurality of kinds of filters to one region according to the size of the region, of obtaining the primary evaluated value corresponding to each feature quantity, and of determining whether or not the region is a candidate region where the specific kind of object exists by comparing a secondary evaluated value and a threshold, the secondary evaluated value being obtained by integrating the plurality of primary evaluated values.

4. The object detecting method according to claim 1, further comprising a region integrating step of integrating, when a plurality of regions are detected in the stepwise detection step, the plurality of regions into one region according to a degree of overlap between the plurality of regions.

5. The object detecting method according to claim 1, further comprising a differential image producing step of obtaining continuous images to produce a differential image between different frames, the continuous images including a plurality of frames, the differential image being used as an image of the object detecting target.

6. The object detecting method according to claim 1, wherein the filter group includes the plurality of filters producing the evaluated values, the evaluated value indicating an existing probability of a human head, and
a detecting target of the object detecting method is the human head appearing in the image.

7. An object detecting apparatus which detects a specific kind of object from an image expressed by two-dimensionally arrayed pixels, the object detecting apparatus comprising:
a filter storage section in which a filter group including a plurality of filters is stored, each of the plurality of filters acting on a region two-dimensionally spread on the image to produce an evaluated value, the evaluated value indicating an existing probability of the specific kind of object in the region, the plurality of filters acting on regions having a plurality of sizes respectively, the number of pixels corresponding to the size of the region on the image being changed at a predetermined rate or changed at the predetermined rate in a stepwise manner in the plurality of sizes;
an image group producing section which produces an image group including an original image of an object detecting target and at least one thinned-out image by thinning out pixels constituting the original image at the predetermined rate or by thinning out the pixels at the predetermined rate in the stepwise manner; and
a stepwise detection section which detects the specific kind of object from the original image by sequentially repeating a plurality of extraction processes from an extraction process of applying a filter acting on a relatively narrow region to a relatively small image toward an extraction process of applying a filter acting on a relatively wide region to a relatively large image,
the plurality of extraction processes including:
a first extraction process of extracting a primary candidate region where an evaluated value exceeding a predetermined first threshold is obtained by applying a first filter in the filter group stored in the filter storage section to a relatively small first image in the image group produced by the image group producing section, the first filter acting on a relatively narrow region; and
a second extraction process of extracting a secondary candidate region where an evaluated value exceeding a predetermined second threshold is obtained by applying a second filter in the filter group stored in the filter storage section to a region corresponding to the primary candidate region in a second image in which the number of pixels is larger than that of the first image in the image group produced by the image group producing section, the second filter acting on a region wider than that of the first filter.

8. The object detecting apparatus according to claim 7, wherein the image group producing section performs an interpolation operation to the original image to produce one interpolated image or a plurality of interpolated images in addition to the image groups, the one interpolated image or the plurality of interpolated images constituting the image group, the number of pixels of the one interpolated image being in a range where the number of pixels is larger than that of the thinned-out image obtained by thinning out the original image at the predetermined rate and smaller than that of the original image, the plurality of interpolated images having the numbers of pixels which are different from one another within the range, and the image group producing section produces a new image group by thinning out pixels constituting the interpolated image at the predetermined rate for each of the produced at least one interpolated image or by thinning out pixels at the predetermined rate in the stepwise manner, the new image group including the interpolated image and at least one thinned-out image obtained by thinning out the pixel of the interpolated image, and
the stepwise detection section detects the specific kind of object from each of the original image and the at least one interpolated image by sequentially repeating the extraction processes to each of the plurality of image groups produced by the image group producing section from the extraction process of applying the filter acting on the relatively narrow region to the relatively small image toward the extraction process of applying the filter acting on the relatively wide region to the relatively large image.

9. The object detecting apparatus according to claim 7, wherein a plurality of kinds of filters are stored in the filter storage section, the plurality of kinds of filters being prepared for each region having one size, each of the plurality of kinds of filters computing an outline of the specific kind of object and one of feature quantities in the specific kind of object,
a correlation between the feature quantity and a primary evaluated value is also stored in the filter storage section, the feature quantity being computed by each filter, the primary evaluated value indicating a probability of the specific kind of object, and
the stepwise detection section computes the plurality of feature quantities by applying the plurality of kinds of filters to one region according to the size of the region, obtains the primary evaluated value corresponding to each feature quantity, and determines whether or not the region is a candidate region where the specific kind of object exists by comparing a secondary evaluated value and a threshold, the secondary evaluated value being obtained by integrating the plurality of primary evaluated values.

10. The object detecting apparatus according to claim 7, further comprising a region integrating section which integrates, when a plurality of regions are detected by the stepwise detection section, the plurality of regions into one region according to a degree of overlap between the plurality of regions.

11. The object detecting apparatus according to claim 7, further comprising a differential image producing section which obtains continuous images to produce a differential image between different frames, the continuous images including a plurality of frames, the differential image being used as an image of the object detecting target.

12. The object detecting apparatus according to claim 7, wherein the filter group including the plurality of filters producing the evaluated values is stored in the filter storage section, the evaluated value indicating an existing probability of a human head, and
a detecting target of the object detecting apparatus is the human head appearing in the image.

13. A storage medium in which an object detecting program is stored, the object detecting program being executed in an operation device, the operation device executing a program, the object detecting program causing the operation device to work as an object detecting apparatus, the object detecting apparatus detecting a specific kind of object from an image expressed by two-dimensionally arrayed pixels, the object detecting apparatus comprising:
a filter storage section in which a filter group including a plurality of filters is stored, each of the plurality of filters acting on a region two-dimensionally spread on the image to produce an evaluated value, the evaluated value indicating an existing probability of the specific kind of object in the region, the plurality of filters acting on regions having a plurality of sizes respectively, the number of pixels corresponding to the size of the region on the image being changed at a predetermined rate or changed at the predetermined rate in a stepwise manner in the plurality of sizes;
an image group producing section which produces an image group including an original image of an object detecting target and at least one thinned-out image by thinning out pixels constituting the original image at the predetermined rate or by thinning out the pixels at the predetermined rate in the stepwise manner; and
a stepwise detection section which detects the specific kind of object from the original image by sequentially repeating a plurality of extraction processes from an extraction process of applying a filter acting on a relatively narrow region to a relatively small image toward an extraction process of applying a filter acting on a relatively wide region to a relatively large image,
the plurality of extraction processes including:
a first extraction process of extracting a primary candidate region where an evaluated value exceeding a predetermined first threshold is obtained by applying a first filter in the filter group stored in the filter storage section to a relatively small first image in the image group produced by the image group producing section, the first filter acting on a relatively narrow region; and
a second extraction process of extracting a secondary candidate region where an evaluated value exceeding a predetermined second threshold is obtained by applying a second filter in the filter group stored in the filter storage section to a region corresponding to the primary candidate region in a second image in which the number of pixels is larger than that of the first image in the image group produced by the image group producing section, the second filter acting on a region wider than that of the first filter.

14. The storage medium according to claim 13, wherein the image group producing section performs an interpolation operation to the original image to produce one interpolated image or a plurality of interpolated images in addition to the image groups, the one interpolated image or the plurality of interpolated images constituting the image group, the number of pixels of the one interpolated image being in a range where the number of pixels is larger than that of the thinned-out image obtained by thinning out the original image at the predetermined rate and smaller than that of the original image, the plurality of interpolated images having the numbers of pixels which are different from one another within the range, and the image group producing section produces a new image group by thinning out pixels constituting the interpolated image at the predetermined rate for each of the produced at least one interpolated image or by thinning out pixels at the predetermined rate in the stepwise manner, the new image group including the interpolated image and at least one thinned-out image obtained by thinning out the pixel of the interpolated image, and
the stepwise detection section detects the specific kind of object from each of the original image and the at least one interpolated image by sequentially repeating the extraction processes to each of the plurality of image groups produced by the image group producing section from the extraction process of applying the filter acting on the relatively narrow region to the relatively small image toward the extraction process of applying the filter acting on the relatively wide region to the relatively large image.

15. The storage medium according to claim 13, wherein a plurality of kinds of filters are stored in the filter storage section, the plurality of kinds of filters being prepared for each region having one size, each of the plurality of kinds of filters computing an outline of the specific kind of object and one of feature quantities in the specific kind of object,
a correlation between the feature quantity and a primary evaluated value is also stored in the filter storage section, the feature quantity being computed by each filter, the primary evaluated value indicating a probability of the specific kind of object, and
the stepwise detection section computes the plurality of feature quantities by applying the plurality of kinds of filters to one region according to the size of the region, obtains the primary evaluated value corresponding to each feature quantity, and determines whether or not the region is a candidate region where the specific kind of object exists by comparing a secondary evaluated value and a threshold, the secondary evaluated value being obtained by integrating the plurality of primary evaluated values.

16. The storage medium according to claim 13, wherein the operation device is caused to work as the object detecting apparatus, the object detecting apparatus further comprising a region integrating section which integrates, when a plurality of regions are detected by the stepwise detection section, the plurality of regions into one region according to a degree of overlap between the plurality of regions.

17. The storage medium according to claim 13, wherein the operation device is caused to work as the object detecting apparatus, the object detecting apparatus further comprising a differential image producing section which obtains continuous images to produce a differential image between different frames, the continuous images including a plurality of frames, the differential image being used as an image of the object detecting target.

18. The storage medium according to claim 13, wherein the filter group including the plurality of filters producing the evaluated values is stored in the filter storage section, the evaluated value indicating an existing probability of a human head, and the object program causes the operation device to work as the object detecting apparatus whose detecting target is the human head appearing in the image.
